(19) United States
(12) Patent Application Publication
(10) Pub. No.: US 2020/0209886 A1
(43) Pub. Date: Jul. 2, 2020

(54) METHOD FOR GUIDING PATH OF UNMANNED AUTONOMOUS VEHICLE AND ASSISTANT SYSTEM FOR UNMANNED AUTONOMOUS VEHICLE THERFOR

(71) Applicant: CUBE AI CO., LTD., Seoul (KR)

(72) Inventors: Jae Sung LEE, Chuncheon-si (KR); Mi Na HEO, Anyang-si (KR)

(73) Assignee: CUBE AI CO., LTD., Seoul (KR)

(21) Appl. No.: 16/234,624

(22) Filed: Dec. 28, 2018

(30) Foreign Application Priority Data
Dec. 28, 2018 (KR) 10-2018-0172395

(51) Int. Cl. G05D 1/02; G08G 1/16; G01S 17/93

(52) U.S. Cl. CPC G05D 1/0276; G08G 1/164; G05D 2201/0213; G01S 17/936; G08G 1/168

(57) ABSTRACT

A method of guiding a path of an unmanned autonomous vehicle using a system for supporting the unmanned autonomous vehicle, includes preparing parking space information; mapping positions of a plurality of intersection cameras and second laser beam projectors provided at each of a plurality of intersections and positions of a plurality of proximity sensors and second laser beam projectors provided in straight line sections, to the parking space information; allocating a driving guidance path including the straight line sections and the intersections to a vehicle to be guided to be driven and determining the proximity sensor and first laser beam projector, the intersection cameras and second laser beam projector, and per-node-direction value included in the driving guidance path; and guiding the vehicle according to a current position of the vehicle and the determined driving guidance path.

### BACKGROUND OF THE INVENTION

### Field of the Invention

The present invention relates to a method of guiding a driving path of a vehicle and, more particularly, to a method of guiding a path of an unmanned autonomous vehicle using a laser beam and a system for supporting an unmanned autonomous vehicle thereby.

### Description of the Related Art

Recently, the vehicle industry has entered the era of environmentally friendly, advanced vehicles that incorporate IT technologies. As vehicle technologies are developed, intelligent vehicles to which accident prevention, accident avoidance, collision safety, convenience improvement, vehicle information, and an autonomous driving technology are applied have been commercialized in order to improve the safety and inconvenience of drivers.

Such intelligent vehicles are vehicles that support technologies compensating for driver carelessness and untrained operation skill, and provide convenience functions through speech recognition, thereby reducing accidents caused by driver negligence as well as expecting advantages such as time reduction, fuel waste reduction, exhaust gas reduction, and the like.

An unmanned autonomous vehicle is a collection of intelligent vehicle technologies in which when the driver rides in a vehicle and then designates a destination, and the unmanned autonomous vehicle can create an optimal path from the current location to the destination without any special operation.

In addition, the unmanned autonomous vehicle can recognize traffic signals and signs on the roads, maintain proper speed in accordance with the traffic flow, actively cope with a dangerous situation to prevent accidents, maintain their own lanes, and properly perform steering to change lanes or overtake other cars and avoid obstacles when necessary, thereby driving to the desired destination.

Especially, in recent years, a technique related to unmanned valet parking has been attempted. Automated valet parking is becoming a solution to various problems, such as city parking environment and lack of parking spaces.

FIG. 22 illustrates an unmanned valet parking system in the related art.

The system shown in FIG. 22 is a technology for guiding fully automatic parking by providing five sensor cameras and ten ultrasonic sensors in the vehicle while providing sensors in the parking plane, which is a combination of intelligent vehicle and road infrastructure-based IT technology.

A key point of this technology is to enable unmanned autonomous parking using the image sensor, irrespective of whether there are obstacles, such as other vehicles. However, this technique can only be used only when a map of a parking lot has been provided in a parking management system in advance. Therefore, when a driver arrives near the parking lot, he or she has to download a map of the corresponding parking lot as an ‘app’, thereby enabling unmanned valet parking.

However, in spite of these advantages, the unmanned valet parking technique in the related art has a problem that a precise GPS map and an image sensor must be used so that it is difficult to apply the technology to an underground parking lot or an indoor parking lot where GPS cannot be used.

In particular, in the underground parking lot, flows of the vehicles are controlled only by an indicator light provided on a ceiling or a wall, a direction indicator light provided on the road surface, and the like, and driving lanes are often not displayed as in the case of an ordinary road.

The autonomous vehicle monitors the driving lane on the road with the camera provided in the vehicle to follow the driving lane, and accordingly it is difficult to perform autonomous driving in an environment where the driving lanes are not displayed on the floor like the parking lot.

There is another method of guiding the driving path through a navigation device provided in the vehicle.

Specifically, by causing a parking lot map to be displayed on the navigation device for a vehicle entering the parking lot, the current position and the moving path of the vehicle are displayed, and a straight movement, a left turn, and a right turn are displayed with arrows.

However, since the method of guiding the driving path using the navigation device in the related art also uses GPS, there are problems that it is difficult to apply the method to an environment where GPS cannot be used, such as in an underground/indoor parking lot, and the method cannot be used for unmanned autonomous driving.

### DOCUMENTS OF RELATED ART

(Patent Document 1) US Patent Application Publication No. US2014/0207326A1

(Patent Document 2) Korean Patent No. 10-1799527

### SUMMARY OF THE INVENTION

Accordingly, the present invention has been made keeping in mind the above problems occurring in the related art, and an object of the present invention is to provide a method of guiding a path of an unmanned autonomous vehicle that enables unmanned autonomous driving even in an environment where GPS cannot be used, such as an underground parking lot.

It is another object of the present invention to provide a method of guiding a path of an unmanned autonomous vehicle that enables autonomous driving even in an environment in which a driving lane is not displayed or incompletely displayed on the floor of a parking lot.

It is still another object of the present invention to provide a system for supporting an unmanned autonomous vehicle that is suitable for the method of guiding a path of an unmanned autonomous vehicle described above.

In order to achieve the object, according to the present invention, there disclosed is a method of guiding a path of an unmanned autonomous vehicle using a system for supporting the unmanned autonomous vehicle, the method including preparing parking space information represented by a two-dimensional coordinate system and including a parking section and a parking plane in a parking lot (parking space information preparation step); mapping positions of a plurality of intersection cameras and second laser beam projectors provided at each of a plurality of intersections and positions of a plurality of proximity sensors and second laser beam projectors provided in straight line sections between the intersections adjacent to each other, to the parking space information (a mapping step); allocating a driving guidance path including the straight line sections and the intersections to a vehicle to be guided to be driven and determining the proximity sensor and first laser beam projectors, the intersection cameras and second laser beam projectors, and per-node (a center point of the intersection)-direction values included in the allocated driving guidance path (path acquisition step); and displaying a lane on which the vehicle moves by the first laser beam projector in the straight line section and displaying a lane on which the vehicle moves by the second beam projector according to the per-node-direction value at the intersection, when guiding the vehicle according to a current position of the vehicle and the determined driving guidance path (path guiding step).

Herein, the method may further include transmitting a section value indicating the straight line section or the intersection and the per-node-direction value to the vehicle.

Herein, the method may further include determining, by the vehicle, a direction value indicated by a laser beam projected on a floor of the parking lot and comparing the direction value with a direction value received by the vehicle to move in a direction indicated by the laser beam when both values match each other, at the intersection.

Herein, the method may further include transmitting, by the vehicle, an error information to the unmanned autonomous driving support system when both values does not match each other; and returning to the driving guidance path acquisition step to reset the driving guidance path and perform the path guiding step again when the unmanned autonomous driving support system receives the error information.

Herein, the path guiding step may include projecting a laser beam indicating a moving direction of the vehicle onto a front parking plane of the vehicle; and reducing a length of the projected laser beam in accordance with a moving speed of the vehicle, wherein the length of the projected laser beam is reduced in accordance with the moving speed of the vehicle to cause the laser beam not to be projected onto a driver's seat of the vehicle.

Herein, a plurality of laser beam projectors for generating laser beams are provided along a direction in which the vehicle moves and a proximity sensor is provided for each of the laser beam projectors to detect whether the vehicle enters and exits a region on which the laser beam is projected, and the reducing of the length of the projected laser beam includes determining the moving speed of the vehicle by analyzing a time between detection signals generated by the proximity sensors.

Herein, the reducing of the length of the projected laser beam may include determining the moving speed of the vehicle by analyzing an image data acquired by capturing the vehicle using a camera.

Herein, when the vehicle reaches a parking position (position adjacent to the parking plane), the laser beam may be no longer projected except for a last section, thereby indicating an end of the guidance path.

Herein, when the vehicle reaches the parking position (position adjacent to the parking plane), the laser beam may be repeatedly turned on or off at the last section, thereby indicating the end of the guidance path.

Herein, when the vehicle reaches a vehicle departure position (position adjacent to an exit), the laser beam may be no longer projected except for a last section, thereby indicating an end of the guidance path.

Herein, when the vehicle reaches the vehicle departure position (position adjacent to the exit), the laser beam may be repeatedly turned on or off at the last section, thereby indicating the end of the guidance path.

In order to achieve another object, an unmanned autonomous driving support system according to the present invention includes an intersection camera and second laser beam projector provided at a node (a center point of an intersection) of a parking space; a proximity sensor and first laser beam projector provided at a straight line section between the nodes; database having a parking section and a parking plane displayed by a two-dimensional coordinate system and storing parking space information to which positions of the intersection camera and second laser beam projector and the proximity sensor and first laser beam projector are mapped; a path setting unit determining a start position and an end position of a vehicle to be guided to be driven, setting a driving guidance path from the start position to the end position by referring the parking space information stored in the database, and determining nodes and per-node-direction values included in the driving guidance path; a path control unit determining a current position of the vehicle on the basis of detection results of the proximity sensor and the intersection camera, and controlling the first laser beam projector and the second laser beam projector according to the determined current position to allow the vehicle to be driven according the driving guidance path; and a communication unit transmitting section values indicating straight line section/intersection and the per-node-direction values to the vehicle by referring the current location and the driving guidance path of the vehicle.

Herein, colors of laser beams for indicating a vehicle entry path and a vehicle departure path may be made different from each other.

Herein, the path control unit may include a straight line section path control unit performing a path control in the straight line section; and an intersection path control unit performing a path control at the intersection.

Herein, the straight line section path control unit may include a proximity sensor output receiving unit receiving a detection signal of the proximity sensor provided in each of the first laser beam projectors in the straight line section; and a straight line section determination and control signal generating unit determining the current position of the vehicle on the driving guidance path by referring the detection signal received by the proximity sensor output receiving unit and a position of the first laser beam projector and generating a control signal that controls an operation of the first laser beam projector according to the determined current position.

Herein, the straight line section path control unit may determine a moving speed of the vehicle on the basis of detection signals of the proximity sensors adjacent to each other and controls a projection range of the first laser beam projector according to the moving speed of the vehicle.

Herein, the system may further include a plurality of straight line section cameras provided in the straight line sections between the nodes to capture an image data of the vehicle; and a straight line section image data receiving unit receiving the image data captured by the straight line section cameras, wherein the straight line section path control unit controls the first laser beam projector on the basis of the position of the vehicle determined by the proximity sensor and the position of the vehicle determined by the straight line section camera.

Herein, the straight line section path control unit may determine a moving speed of the vehicle on the basis of the detection signal of the adjacent proximity sensors and the image signal of the straight line section camera and adjust a projection range of the first laser beam projector according to the moving speed of the vehicle.

Herein, the intersection path control unit may include an intersection image data receiving unit receiving an image data provided by the intersection camera capturing the vehicle entering the intersection; and an intersection determination and control signal generating unit analyzing the image data received by the image data receiving unit to determine whether the vehicle enters the intersection and generating a control signal controlling an operation of the second laser beam projector according to the determination result.

Herein, a curvature of the laser beam projected at the intersection may be made different according to a width of the vehicle, a length of the vehicle, and a road width.

Herein, colors of the laser beams may be made different when two or more vehicles intersect with each other at the intersection.

Herein, the intersection path control unit may determine a moving speed of the vehicle on the basis of the image signal of the intersection camera and adjust a projection range of the second laser beam projector according to the moving speed of the vehicle not to project the laser beam onto a driver's seat of the vehicle.

Herein, the second laser beam projector may include first to third sub laser beam projectors generating laser beams to be projected on a floor of the parking lot respectively; and a controller controlling the first to third sub laser beam projectors according to control of the intersection path control unit, wherein the first and third sub laser beam projectors project laser beams having predetermined curvatures, respectively, and the second sub laser beam projector projects a linear laser beam.

The method of guiding a path of an unmanned autonomous vehicle according to the present invention has an effect in that since the vehicle is guided by using the laser beam projected on the floor of the parking lot, the vehicle can be safely guided even in an environment without GPS.

The system for supporting an unmanned autonomous vehicle according to the present invention has an effect of enabling a vehicle to follow a lane by a line tracing method by projecting the vehicle moving direction using a laser beam in accordance with the vehicle position on the driving guidance path.

### BRIEF DESCRIPTION OF THE DRAWINGS

The above and other objects, features and other advantages of the present invention will be more clearly understood from the following:

FIG. 1 shows a top view of a parking lot represented by parking space information;

FIG. 2 shows an example of an image captured by an entrance-side camera;

FIG. 3 shows an example of a vehicle entry path;

FIG. 4 schematically shows the concept of a method of guiding a path of an unmanned autonomous vehicle according to the present invention;

FIG. 5 shows diagrams illustrating an example of laser beam projection in a straight line section;

FIG. 6 shows diagrams illustrating an example of a first laser beam projector;

FIG. 7 shows diagrams illustrating an example in which a length of the projected laser beam is controlled to decrease as the vehicle moves;

FIG. 8 shows diagrams illustrating another example of a first laser beam projector;

FIG. 9 shows diagrams illustrating an embodiment of a second mask shown in FIG. 8B;

FIG. 10 shows diagrams illustrating an example of laser beam projection in an intersection;

FIG. 11 shows an example of the second laser beam projector;

FIG. 12 shows diagrams illustrating a configuration of the sub laser generator shown in FIG. 11;

FIG. 13 shows an example in which the curvature of a laser beam projected from the second laser beam projector is controlled;

FIG. 14 shows a configuration for adjusting the length of laser beams from the first and third sub laser beam projectors;

FIG. 15 is a flowchart illustrating a method of guiding a path of an unmanned autonomous vehicle according to the present invention;

FIG. 16 is flow diagrams showing an embodiment of a method of guiding a path of an unmanned autonomous vehicle at the time of vehicle entry according to the present invention;

FIG. 17 is flow diagrams showing another embodiment of a method of guiding a path of an unmanned autonomous vehicle at the time of vehicle departure according to the present invention;

FIG. 18 is a block diagram showing a configuration of a system for supporting an unmanned autonomous vehicle to which a method of guiding a path of an unmanned autonomous vehicle is applied according to the present invention;

FIG. 19 shows a configuration of a straight line section path control unit;

FIG. 20 shows a configuration of an intersection path control unit;

FIG. 21 shows another example of a parking lot; and

FIG. 22 illustrates an unmanned valet parking system in the related art.

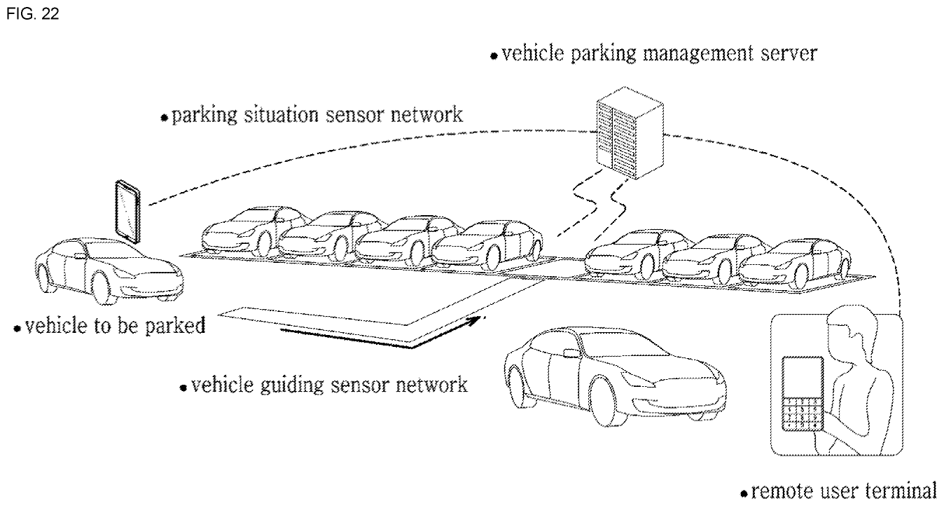

### DETAILED DESCRIPTION OF THE INVENTION

While the present invention has been described in connection with certain exemplary embodiments, it is to be understood that the invention is not limited to the disclosed embodiments, but, on the contrary, is intended to cover various modifications and similarities. It is to be understood, however, that the invention is not to be limited to the specific embodiments, but includes all modifications, equivalents, and alternatives falling within the spirit and scope of the invention. Similar reference numerals are used for similar elements in describing each drawing.

The terms such as first, second, A, B, etc. may be used to describe various components, but the components should not be limited by the terms. The terms are used only for the purpose of distinguishing one component from another. For example, without departing from the scope of the present invention, the first component may be referred to as a second component, and similarly, the second component may also be referred to as a first component. The term of and/or includes any combination of a plurality of related listed items or any of a plurality of related listed items.

It is to be understood that when an element is referred to as being “connected” or “coupled” to another element, the element may be directly connected or coupled to another element or still other elements may be located in between. On the other hand, when an element is referred to as being “directly connected” or “directly coupled” to another element, it should be understood that there are no other elements in between.

The terminology used herein is for the purpose of describing particular embodiments only and is not intended to be limiting of the invention. The singular forms include plural referents unless the context clearly dictates otherwise. In this application, the terms “comprising” or “having”, etc. are used to specify that there is a stated feature, figure, step, operation, element, part or combination thereof, and that one or more other features and does not preclude the presence or addition of one or more other features, integers, steps, operations, elements, components, or combinations thereof.

Unless defined otherwise, all terms used herein, including technical or scientific terms, have the same meaning as commonly understood by one of ordinary skill in the art to which this invention belongs. Terms such as those defined in commonly used dictionaries are to be interpreted as having a meaning consistent with the meaning of the context in the relevant art and are to be construed in an ideal or overly formal sense unless expressly defined in the present application.

Hereinafter, the configuration and operation of the present invention will be described in detail with reference to the accompanying drawings.

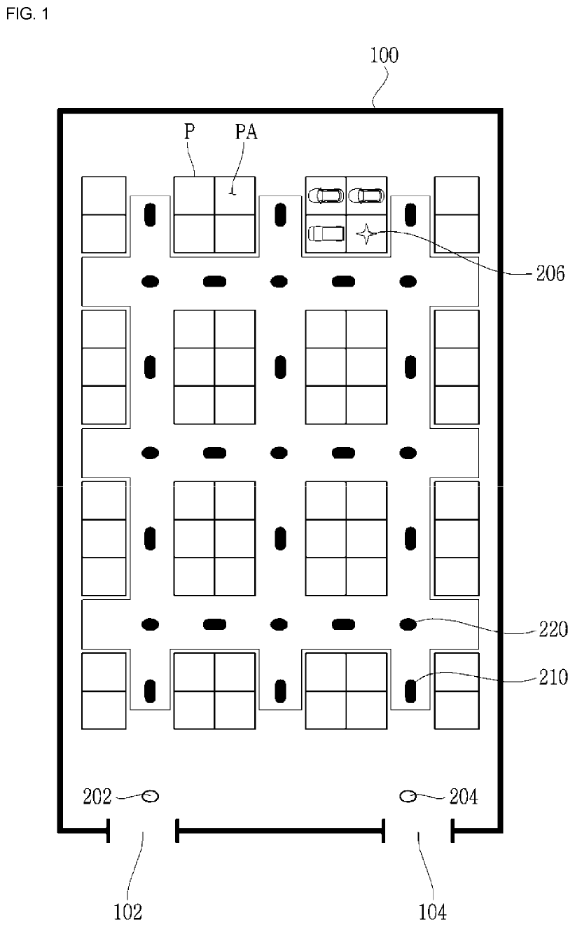

FIG. 1 shows a top view of a parking lot represented by parking space information.

Referring to FIG. 1, a parking lot 100 includes a plurality of parking sections P, each section P including a plurality of parking planes PA. The parking space information is a two-dimensional map in which the parking sections and the parking planes are expressed, and the positions of the respective components are represented by X and Y coordinates. The parking planes PA may be provided to have different heights and widths so as to accommodate vehicles having different heights and widths.

An entrance-side camera 202 and an exit-side camera 204 are provided at the entrance 102 and the exit 104 of the parking lot to detect the entry and departure of the vehicle, respectively.

The positions of the entrance-side camera 202 and the exit-side camera 204 are represented by a red circle shown adjacent to the entrance 102 and the exit 104 in FIG. 1.

The roads of the parking lot include straight line sections and intersection sections. A proximity sensor and first laser beam projector 210 for measuring the distance to the vehicle are provided for each straight line section and an intersection camera and second laser beam projector 220 are provided at the center point (node) of each intersection.

The proximity sensor and first laser beam projector 210 may be provided, for example, in a portion indicated by a light blue box in FIG. 1, and the intersection camera and second laser beam projector 220 may be provided in a portion indicated by a red circle in FIG. 1.

The proximity sensor and first laser beam projector 210 may be configured such that the proximity senor 210a and the first laser beam projector 210b are provided to be integrated in one box or may be separately provided adjacent to each other. In the present invention, an example in which the proximity sensor 210a and the first laser beam projector 210b are provided to be integrated will be described.

The proximity sensor and first laser beam projector 210 are provided on a ceiling of the parking lot, and the first laser beam projector 210b projects a linear laser beam on the floor of the parking lot.

The intersection camera and second laser beam projector 220 may be also configured such that the proximity sensor 210a and the first laser beam projector 210b are provided to be integrated in one box or may be separately provided adjacent to each other. In the present invention, an example in which the intersection camera 220a and the second laser beam projector 220b are provided adjacent to each other will be described.

The intersection camera and second laser beam projector 220 are provided on a ceiling of the parking lot, and the second laser beam projector 220b projects a linear laser beam or an arc-shaped laser beam having a predetermined curvature on the floor of the parking lot.

The positions of a plurality of intersection cameras and second laser beam projectors 220 provided at the node (center point of the intersection) and positions of a plurality of proximity sensors and first laser beam projectors 210 provided in the straight line section between intersections are mapped to the parking space information.

In each parking plane PA, a parking state detection sensor 206 for detecting whether or not the vehicle is parked on the corresponding parking plane is provided. The position of the parking state detection sensor 206 may be a place indicated by a green star in FIG. 1. The parking state detection sensor 206 may be a loop sensor buried in the parking plane PA, an optical sensor provided on the wall to detect whether a vehicle is located or not on the parking plane PA, or a proximity sensor provided on the ceiling of the parking plane PA.

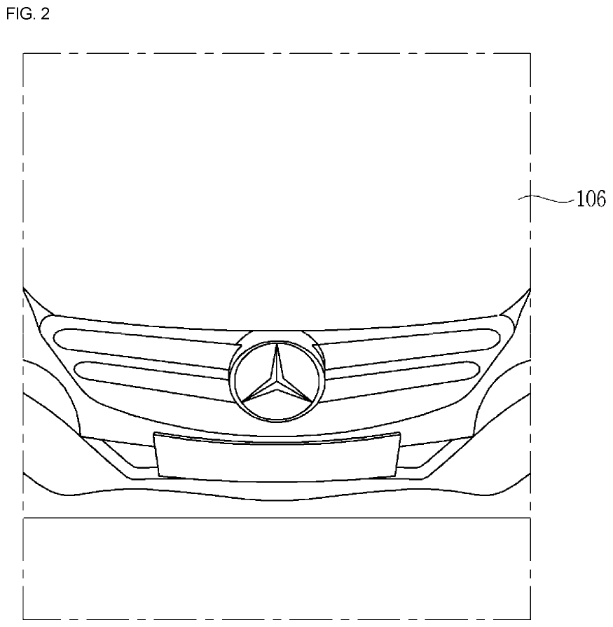

FIG. 2 shows an example of an image captured by an entrance-side camera.

When the vehicle entry detector (not shown) provided in the entrance 102 to the parking lot has detected that the vehicle 106 enters the parking lot 100, the entrance-side camera 202 captures an image of the vehicle 106 entering the parking lot, so that the captured image is analyzed to detect the number plate, the height, the width, and the like of the vehicle 106. Information relating to the entering vehicles such as the vehicle number, the height, the width, and the like of the vehicle is provided to the path generation unit (not shown). The path generation unit selects a parking plane PA suitable for the vehicle 106 and determines the vehicle entry path to the corresponding parking plane PA, and nodes and directional values for each node included in the entry path. The parking plane PA suitable for the vehicle 106 entering the parking lot may be selected depending on the type, the width, the length, and the like of the vehicle.

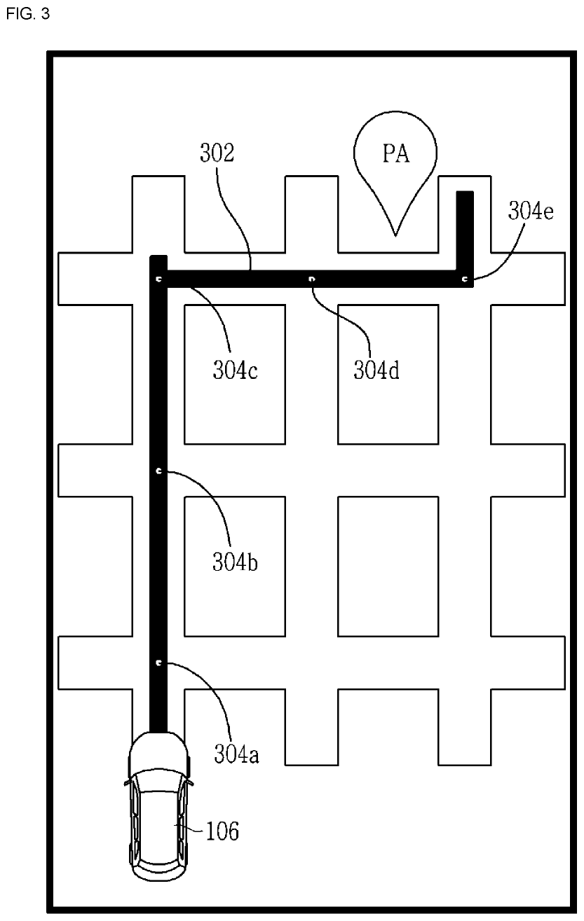

FIG. 3 shows an example of a vehicle entry path. Referring to FIG. 3, it will be appreciated that a path to the selected parking plane (PA_selected), i.e., a vehicle entry path 302, is indicated by red lines. The vehicle entry path 302 includes a plurality of the straight line sections and a plurality of the intersections. The vehicle entry path includes, for example, nodes 304a, 304b, 304c, 304d, and 304e and direction values (right turn/straight/left turn) at each node.

Accordingly, the path control in the method of guiding a path of an unmanned autonomous vehicle according to the present invention may configured of a lane displaying procedure in the straight line sections and a lane displaying procedure according to left or right turns at the nodes.

Here, the straight line section refers to a section where there is no lane that branches in the middle even when there is some curvature, and the intersection refers to a section where two or more lanes intersect or diverge from each other. Only going straight is possible in the straight line section, and turning may be performed in the intersection.

In the method of guiding a path of an unmanned autonomous vehicle according to the present invention, the current position of the vehicle is detected by the proximity sensor 210a, and the vehicle is guided on a lane to the intersection by the first laser beam projector 210b, in terms of the straight line section. A plurality of first laser beam projectors 210b may be successively arranged along the lane in a case where the straight line section is long enough not to be covered by only one laser beam projector 210b. The first laser beam projector 210b is provided on the ceiling of the underground parking lot to project the laser beam on the floor 46 of the parking lot.

At the intersection, the intersection camera 220a detects whether the vehicle has entered the intersection, and when the vehicle has entered the intersection, the vehicle is guided to be turned or driven straight by the second laser beam projector 220b according to the direction value of the node. The second laser beam projector 220b is also provided on the ceiling of the underground parking lot to project the laser beam on the floor 46 of the parking lot.

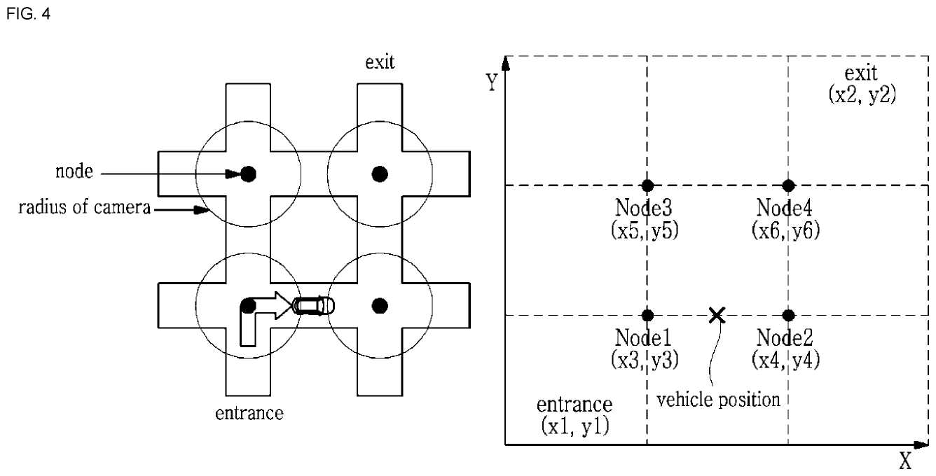

FIG. 4 schematically shows the concept of a method of guiding a path of an unmanned autonomous vehicle according to the present invention.

Referring to FIG. 4, it may be seen that the position of the vehicle may be specified by the nodes and the distance between two nodes.

Here, the node is the center point of the intersection, and the intersection camera and second laser beam projector 220 are provided at the node. The capturing range of the intersection camera 220a is set enough to cover the intersection.

It is assumed that the straight line section is actually between the intersections, and in most cases this assumption is suitable.

The proximity sensor and first laser beam projector 210 are provided between the nodes, and the intersection camera and second laser beam projector 220 are provided at the node (see FIG. 1).

Here, the proximity sensor and first laser beam projector 210 includes a proximity sensor 210a and a first laser beam projector 210b. The intersection camera and second laser beam projector 220 include an intersection camera 220a and a second laser beam projector 220b.

The first laser beam projector 210b is used for displaying a straight driving lane in the straight line section, and the second laser beam projector 220b is used for displaying the direction of turning/going straight at the intersection.

When the vehicle has started to be detected by the intersection camera 220a provided at the node, it is recognized that the vehicle 106 has entered the intersection. By recognizing the vehicle number of the vehicle 106 that has entered the intersection and referring to the path set for the vehicle 106 on the basis of the vehicle number, the directions (turning/going straight) necessary to allow the vehicle 106 to move to the next node are indicated. To this end, the second laser beam projector 220b is turned on so that the turning direction is displayed to guide the vehicle 106 according to the direction values of the corresponding node.

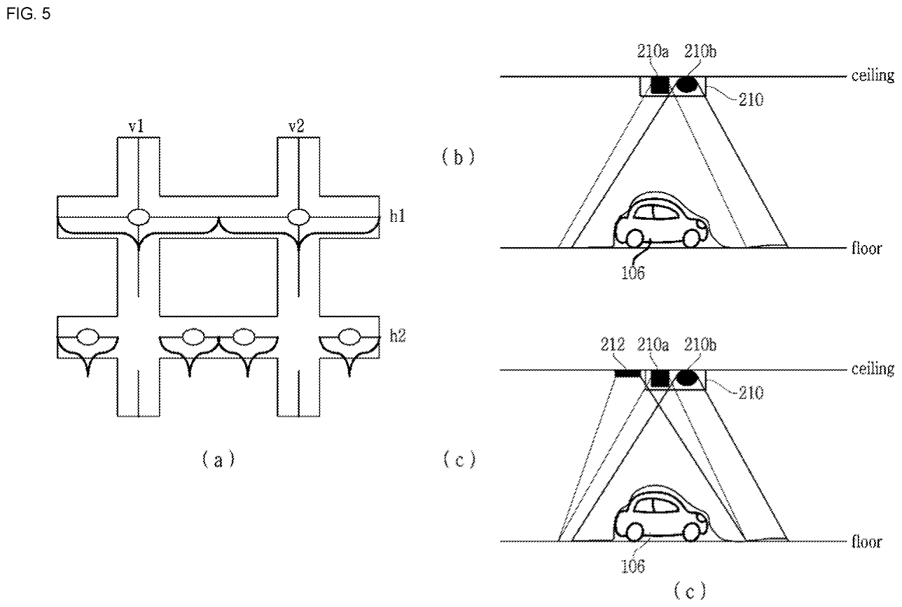

FIGS. 5A, 5B, and 5C are diagrams illustrating an example of laser beam projection in a straight line section.

Referring to FIG. 5A, each straight line section may be divided into vertical sections (V1, V2 , , , ) and horizontal sections (H1, H2 , , , ). The length of the laser beam in each straight line section may vary depending on the performance of the first laser beam projector 210b. In FIGS. 5A, 5B and 5C, laser beams of different lengths are shown. Here, although the laser beam of the straight line section may be provided so as to overlap the laser beam of the intersection as shown in a straight line section hl, the laser beam of the straight line section is preferably provided so as not to overlap with the laser beam of the intersection, as shown in a straight line section h2.

As shown in FIG. 5B, the proximity sensor 210a is provided together with the first laser beam projector 210b in each straight line section to determine the vehicle position in the straight line section.

The proximity sensor 210a detects that the vehicle 106 is entering or leaving a sensing range and may specify the position of the vehicle by the sensing range of the proximity sensor 210a. That is, the fact that the vehicle is within the sensing range of the proximity sensor 210a indicates that the current position of the vehicle is adjacent to the position of the proximity sensor 210a.

The proximity sensor 210a may be implemented as a diffusion type photo-detector, an ultrasonic detector, and the like. Alternatively, it may be implemented by combining one photo-detector that detects the vehicle coming into the sensing range and another photo-detector that detects the vehicle going out of the sensing range. The proximity sensor 210a is also useful for specifying the position of the vehicle, as well as adjusting the projection range (or the length of the projected laser beam) of the laser beam to be described later.

As another method for specifying the current position of the vehicle, it may be considered to provide another camera (a straight line section camera 212) further provided as shown in FIG. 5C, in which the reliability of the positioning may be more enhanced than the case in which only the proximity sensor 210a is provided.

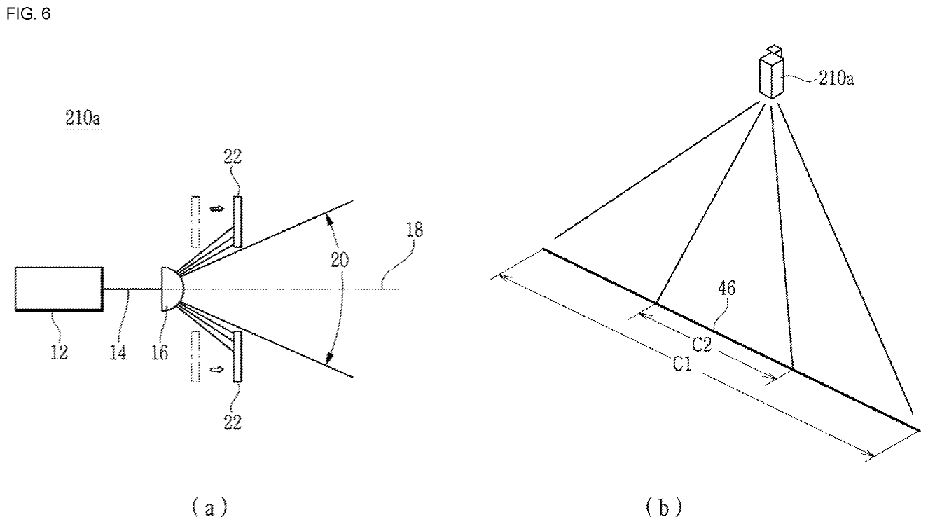

FIGS. 6A and 6B are diagrams illustrating an example of a first laser beam projector.

Referring to FIG. 6A, the first laser beam projector 210b includes a laser generator 12 for generating a laser beam 14, a diffusion lens 16, and a mask 22. The laser generator 12 may selectively generate one of a plurality of colored laser beams. For example, the laser generator 12 may be provided with three colors RGB laser diodes to selectively operate one of three colors RGB laser diodes. It is necessary for the first laser beam projector 210b to generate laser beams of different colors, in order to generate a laser beam of a color distinguishable from the color of the floor of the parking lot, as well as to distinguish the vehicle entry path from the vehicle departure path.

The laser beam 14 generated by the laser generator 12 is diffused by the diffusion lens 16 and adjusted by adjusting the position of the mask 22 to the left and right to adjust a diffusion angle 20, i.e., a projection range of the laser beam.

Referring to FIG. 6B, it is shown that the first laser beam projector 210b is provided on the ceiling of the parking lot to project a laser beam on the floor 46 of the parking lot. It will be appreciated that the lengths C1 and C2 of the laser beam projected onto the floor 46 of the parking lot are adjusted by adjusting the position of the mask 22.

It is preferable that the laser beam projected on the floor 46 is controlled such that length thereof is reduced as the vehicle moves. Projecting the laser beam directly to a driver or passengers is not desirable. Accordingly, it is preferable that the length of the laser beam projected from the first laser beam projector 210b is controlled to be reduced so that the laser beam is not projected onto the vehicle, particularly the front window of the vehicle, as the vehicle moves.

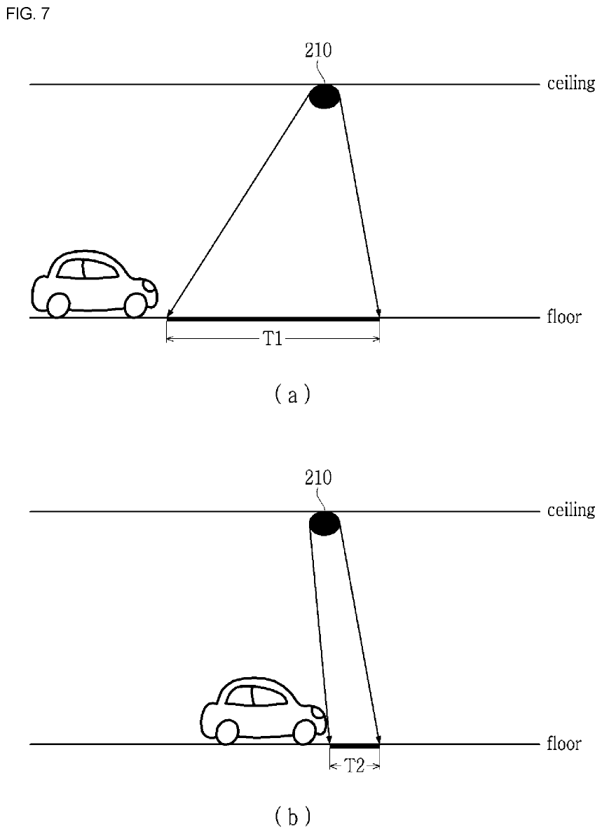

FIGS. 7A and 7B are diagrams illustrating an example in which a length of the projected laser beam is controlled to decrease as the vehicle moves.

FIG. 7A shows a state before the vehicle enters the projection range of the laser beam, and FIG. 7B shows a state where the vehicle is within the projection range. The laser beam is projected by a length T1 in FIG. 7A, but the laser beam is projected by a length T2 (T2<T1) in FIG. 7B. As the vehicle moves, the length of the laser beam projected is reduced so that the laser beam is not projected onto a driver's seat of the vehicle.

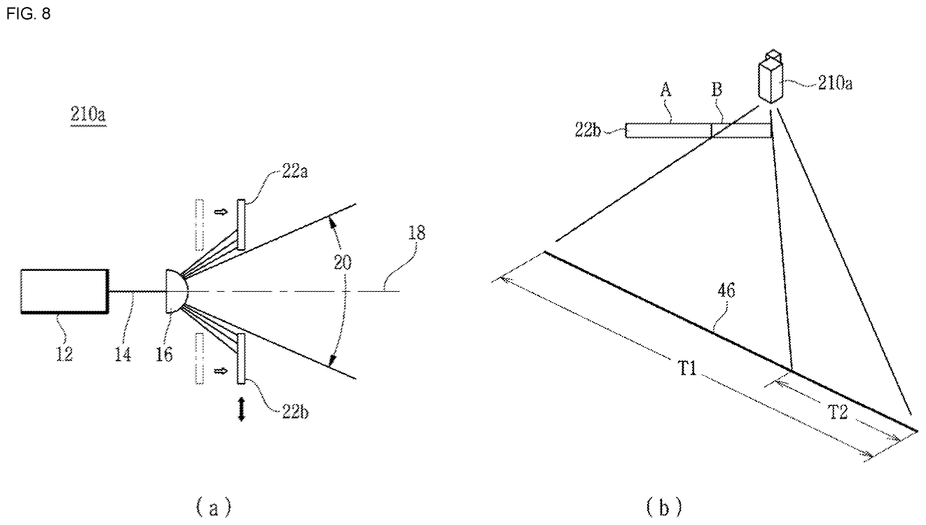

FIGS. 8A and 8B are diagrams illustrating another example of a first laser beam projector.

The first laser beam projector 210b shown in FIGS. 8A and 8B is provided to reduce the length of the projected laser beam as the vehicle moves.

Referring to FIG. 8A, the mask 22 includes a first mask 22a and a second mask 22b, and the second mask 22b is configured to block the light path by moving toward the optical axis in a direction perpendicular to the optical axis. The second mask 22b may be controlled to be moved until the second mask 22b is in contact with the first mask 22a to completely block the laser beam.

Referring to FIG. 8B, it will be appreciated that the length of the laser beam changes by adjusting the position of the second mask 22b (T1>T2).

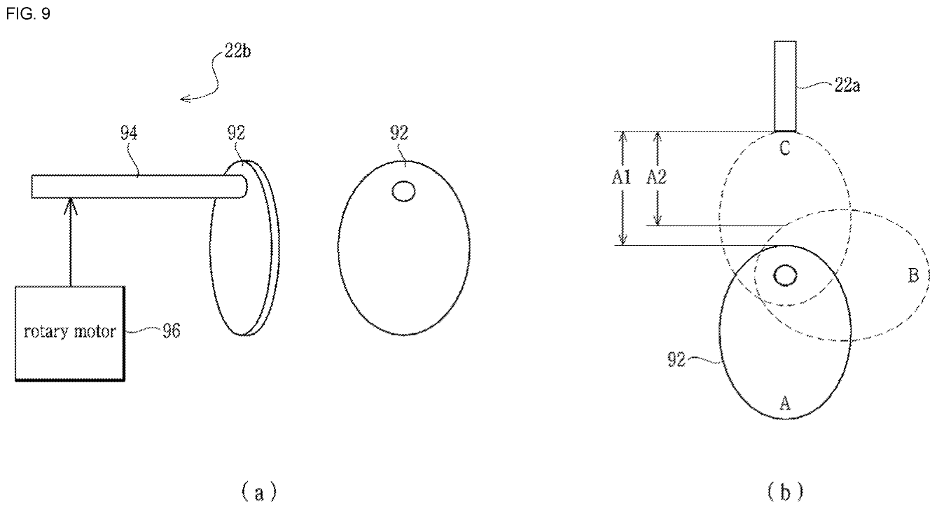

FIGS. 9A and 9B are diagrams illustrating an embodiment of a second mask shown in FIGS. 8A and 8B.

The second mask 22b may be embodied as a disk 92, a rotary shaft 94, and a rotary motor 96. When the rotary shaft 94 is rotated by the rotary motor 96, the disk 92 is rotated accordingly. The projection ranges A1 and A2 of the laser beam change depending on the rotational positions A, B and C of the disk 92, and as a result, the length of the projected laser beam is changed.

It is necessary to match the position and the moving speed of the vehicle when controlling the length of the projected laser beam.

The position of the vehicle may be determined by the proximity sensor 210a. When the proximity sensor 210a detects that the vehicle has entered the projection range of the laser beam, the current position of the vehicle may be specified with reference to the position of the proximity sensor 210a.

The moving speed of the vehicle may be determined in various ways. When the proximity sensor 210a is used, the vehicle movement speed between proximity sensors 210a adjacent to each other may be obtained and applied. When the straight line section camera 212 is used, the moving speed of the vehicle may be obtained by analyzing the image of the straight line section camera 212.

Alternatively, the moving speed of the vehicle may be determined by receiving on-board diagnostics (OBD) information from the vehicle. The OBD is a device that diagnoses the condition of the vehicle and informs the result. Recently produced vehicles are equipped with sensors for various measurements and controls, and the sensors are controlled by an electronic control unit (ECU). Although the ECU was originally developed to precisely control the engine's core functions, such as ignition timing, fuel injection, variable valve timing, idling, and threshold setting, and the like, the ECU controls all parts, such as the drive system, brake system, steering system, and the like of the vehicle in addition to automatic transmission with development of vehicle and computer performance. Such an ECU has been continuously developed to provide standard diagnostic system called on-board diagnostic version II (OBD-II).

When the position and the moving speed of the vehicle are determined by receiving the OBD information from the vehicle, the detection signal of the proximity sensor 210a may be used to correct the current position and the moving speed of the vehicle.

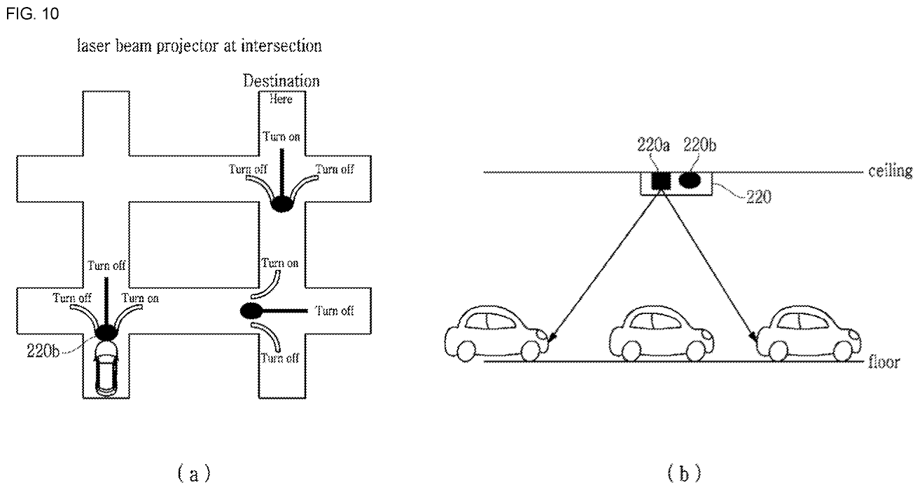

FIGS. 10A and 10B are diagrams illustrating an example of laser beam projection at an intersection.

Referring to FIG. 10A, the second laser beam projector 220b is provided in each node to make a change of direction at the intersection.

The length of the laser beam may vary depending on the performance of the second laser beam projector 220b.

A curvature is calculated in consideration of a lateral width of the vehicle, a road width, etc. and then reflected in a curvature of the laser beam for the purpose of the vehicle's making a change of direction (left turn/straight/right turn) at the intersection.

The second laser beam projector 220b may be configured of a combination of three sub projectors, i.e., a first sub laser beam projector for displaying a left turn signal, a second sub laser beam projector for displaying a straight signal, and a third sub laser beam projector for displaying a right turn signal.

One of the three sub laser beam projectors is turned on to guide the direction according to the direction value at the corresponding node.

Referring to FIG. 10B, the intersection camera 220a is provided together with the second laser beam projector 220b to determine the position of the vehicle. By analyzing the image data generated by the intersection camera 220a, information such as the vehicle number, the vehicle width, and the length of the vehicle may be obtained.

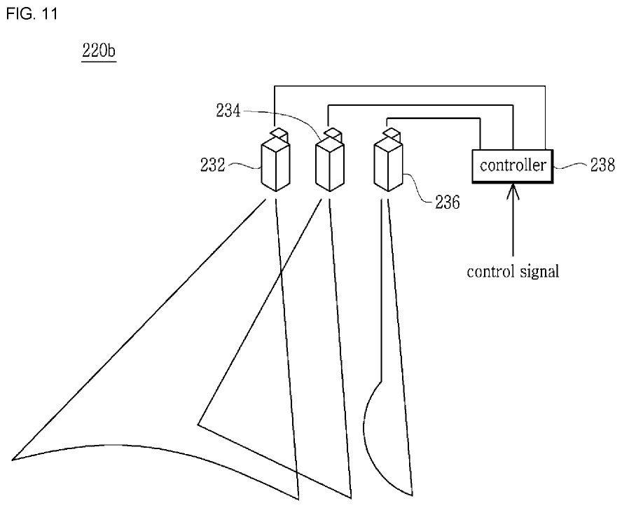

FIG. 11 shows an example of the second laser beam projector

Referring to FIG. 11, the second laser beam projector 220b has three sub laser beam projectors 232, 234, and 236 and a controller 238. Each of the sub laser beam projectors 232, 234, and 236 generates laser beams for indicating the left turn signal, the straight signal, and the right turn signal. The controller 238 controls the sub laser beam projectors 232, 234, and 236. The control signals are signals for controlling on/off of the sub laser beam projectors 232, 234, and 236, the curvature of the laser beam, and the length of the laser beam.

In the second laser beam projector 220b shown in FIG. 11, the second sub laser beam projector 234 may have the configuration shown in FIGS. 6 to 9.

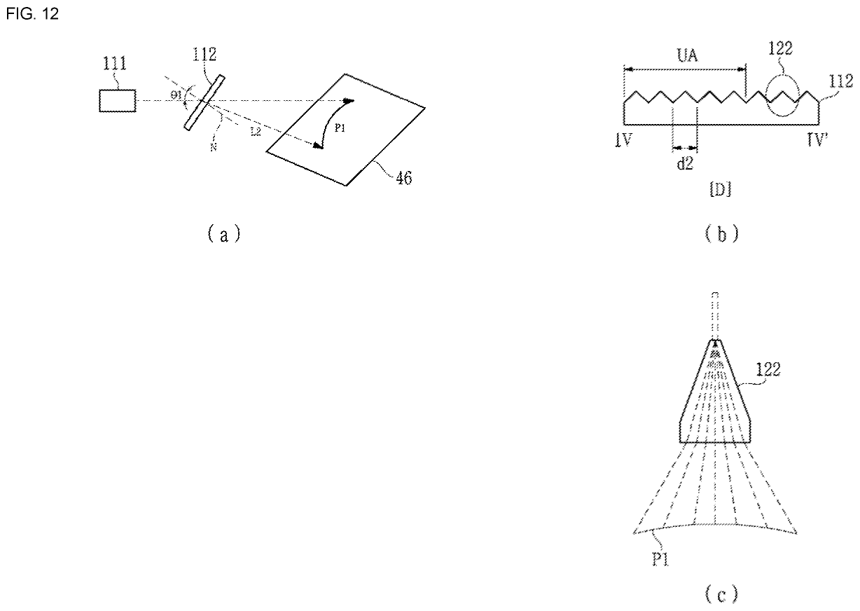

FIGS. 12A, 12B, and 12C are diagrams illustrating a configuration of the sub laser generator shown in FIG. 11.

Referring to FIG. 12A, each of the first and third sub laser beam projectors 232 and 236 includes a laser generator 111 generating a laser beam, a lenticular lens 112, and a rotation motor (not shown) rotating the lenticular lens 112 to adjust an angle θ between the normal line of the lenticular lens 112 and the optical axis.

The laser generator 111 may selectively generate one of several colored laser beams. For example, the laser generator 12 may be provided with three colored RGB laser diodes to selectively drive one of three RGB laser diodes. It is also necessary for the second laser beam projector 220b to generate laser beams of different colors, in order to generate a laser beam of a color distinguishable from the color of the floor of the parking lot, as well as to distinguish the vehicle entry path and the vehicle departure path.

When the laser generator 111 emits light onto the optical axis, a second light path L2 is determined by the angle with the normal line N of the prism pattern lens 121, and then a linear line or a curve having a predetermined curvature is projected onto the floor 46 of the parking lot.

Referring to FIGS. 12B and 12C, the lenticular lens 112 has a teeth shaped surface 122, and the laser light is diffused by the respective teeth 122. Herein, the curvature of the laser beam projected on the floor 46 of the parking lot may controlled by changing angle θ between the normal line of the lenticular lens 112 and the optical axis.

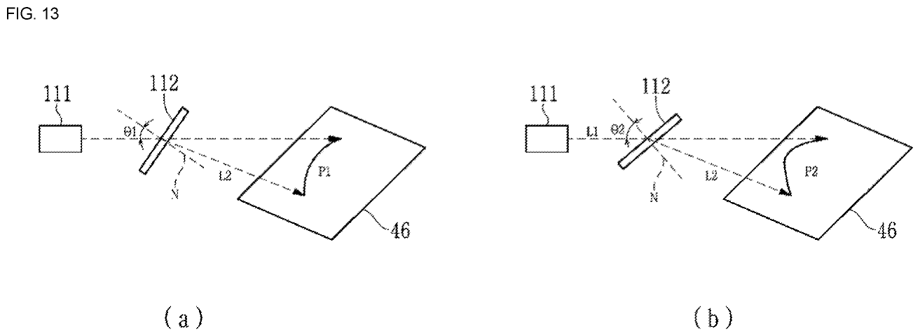

FIGS. 13A and 13B show an example in which the curvature of the laser beam projected from the second laser beam projector is controlled.

FIGS. 13A and 13B illustrate controlling the curvatures of the projected laser beams P1 and P2 by changing the angle θ between the normal line N of the lenticular lens 112 and the laser beam.

As the angle θ between the optical axis and the normal line N gradually increases from 0° and approaches 90°, the curvature increases in proportion thereto. That is, when the second incident angle θ2 is larger than the first incident angle θ1 (θ2>θ1), the curvature of the second line shape P2 becomes larger than the first line shape P1.

At the intersection, the curvatures of the laser beams indicating right turn/left turn are varied depending on the type of vehicle, vehicle width, vehicle length, and road width. For example, the curvatures of the laser beams may be displayed differently from each other in the case of a vehicle with a short vehicle length and a vehicle with a long vehicle length, thereby guiding the vehicle 106 to be driven safely.

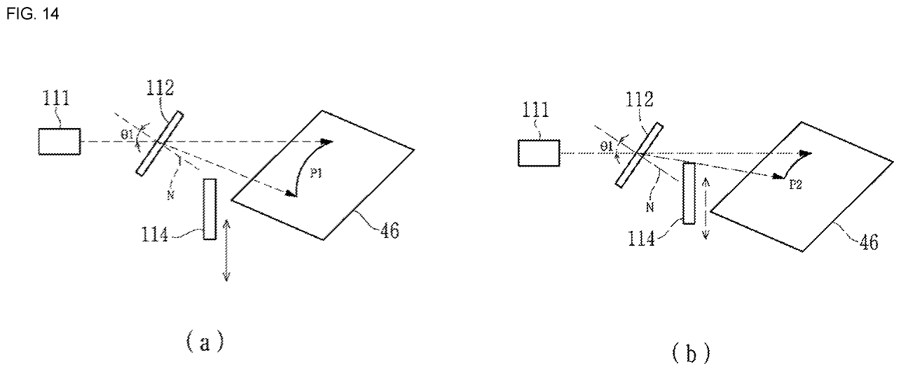

FIGS. 14A and 14B show a configuration for adjusting the length of the laser beams from the first and third sub laser beam projectors.

Referring to FIGS. 14A and 14B, it may be seen that the length of the projected laser beam is adjusted by moving a blocking plate 114 in a direction perpendicular to the optical axis.

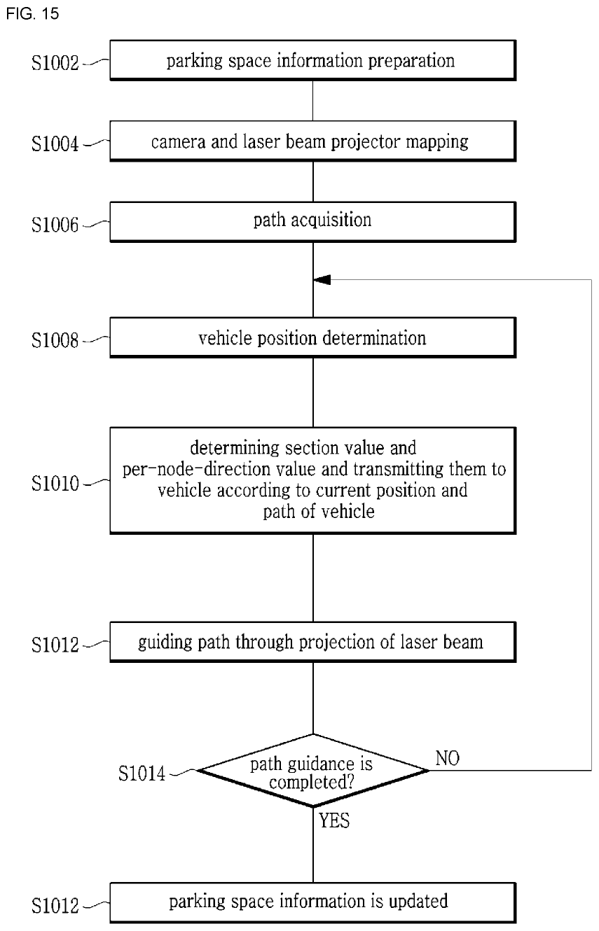

FIG. 15 is a flowchart illustrating a method of guiding a path of an unmanned autonomous vehicle according to the present invention.

The method of guiding a path of an unmanned autonomous vehicle according to the present invention is provided such that the laser beam is projected onto the floor to display a lane in which the vehicle moves, a linear laser beam is generated by the first laser beam projector 210b in the straight line section, and a laser beam indicating left turn/straight/right turn is generated by the second laser beam projector 220b, thereby guiding the vehicle.

Referring to FIG. 15, the a method of guiding a path of an unmanned autonomous vehicle according to the present invention includes a parking space information preparation step S1002, an intersection camera and laser beam projector mapping step S1004, a path acquisition step S1006, a vehicle position determination step S1008, a communication step S1010, and a path guiding step S1012.

First, parking space information expressed by a two-dimensional coordinate system and including a parking area and a parking plane (parking place), is prepared (parking space information preparation step, S1002).

A two-dimensional map (parking lot map) is created by measuring the positions of wall, column, parking sections of the parking lot, and the parking plane using a laser distance measuring device. In the two-dimensional map, a parking area, a parking plane, and the like are set.

A plurality of nodes (herein, node is the center point of the intersection), the positions of a plurality of intersection cameras and second laser beam projectors 220 provided on each of the nodes, and the positions of a plurality of proximity sensors and first beam projector 210 provided on the straight line section between the nodes are mapped to the parking space information (mapping step, S1004).

The intersection camera and second laser beam projector 220 is provided at each node (the center point of the intersection), and the proximity sensor and first laser beam projector 210 is provided between the nodes, in which their positions are mapped to the parking map.

A driving guidance path (vehicle entry path or vehicle departure path) including the straight line section and the intersection is allocated to the entering or departing vehicle, and the proximity sensor and first laser beam projector 210, the intersection camera and second laser beam projector 220, and the direction values at each node included in the allocated driving guidance path are determined (path acquisition step, S1006).

At the time of vehicle entry, a license plate, a vehicle height, a vehicle width, a length of the vehicle, etc. are detected by an entrance-side camera 202 provided at the entrance, and an appropriate parking plane PA is allocated with reference to the parking space information, whereby a path (vehicle entry path) necessary to reach the corresponding parking plane PA is acquired. At the time of vehicle departure, the start of the departure is detected by a parking state detecting sensor, a smart phone application, and the like, and a path (vehicle departure path) necessary to reach the exit is acquired.

The current position of the vehicle is determined (S1008). The current position of the vehicle may be determined by determining whether the vehicle is at the intersection or in the straight line section. When the vehicle is at the intersection, the location of the vehicle is specified by the intersection camera 220a provided at each node. When the vehicle is in a straight line section, the position of the vehicle is specified by the proximity sensor 210a or a straight line section camera 212 provided separately in the straight line section.

The section value and the per-node-direction value are determined according to the current position of the vehicle and the driving guidance path allocated to the corresponding vehicle, and the determination is transmitted to the vehicle (communication step, S1010).

The vehicle is guided according to the determined driving guidance path (path guiding step, S1008).

Here, the guidance is performed by displaying a lane on which the vehicle is to move using the first laser beam projector 210b in the straight line section, and determining the vehicle number and the position using the provided at the node and displaying a lane on which the vehicle is to move using the second laser beam projector 220b in accordance with the direction value at the node in the intersection.

When the vehicle reaches a parking position (a position adjacent to the parking plane), the laser beam projected by the laser beam projector 210b or 220b is no longer displayed, thereby indicating the end of the guidance path. Alternatively, the laser beam projector 210b or 220b is repeatedly turned on or off at the last section, thereby indicating the end of the guidance path.

A system for supporting an unmanned autonomous vehicle (hereinafter, referred to an “unmanned autonomous vehicle supporting system”) determines whether or not the vehicle 106 has reached the parking position, while determining the situation around the vehicle 106 by using a camera provided in the parking lot.

It is also possible to indicate the parking position using the laser beam, as well as the parking position indicator provided on the parking plane PA.

Specifically, a parking position indicator for emitting a laser beam is provided on the floor of the parking plane PA. When the vehicle 106 to be parked approaches the corresponding parking plane PA, a parking position indicator provided on the parking plane PA is turned on to notify the parking plane PA. Alternatively, the parking plane number may be transmitted to the vehicle 106, and the vehicle 106 may recognize the parking plane number through a built-in camera.

When the path guidance is completed, the parking space information is updated (S1012, S1014).

The method according to the present invention may be used in combination with the parking guiding method using the navigation device in the related art. For example, the vehicle 106 may display the section values and the per-node-direction values received by the vehicle 106 on the navigation screen. That is, on the parking lot map of the navigation device, a straight arrow may be displayed in the straight line section, and right turn/straight/left turn arrows may be displayed in the intersection.

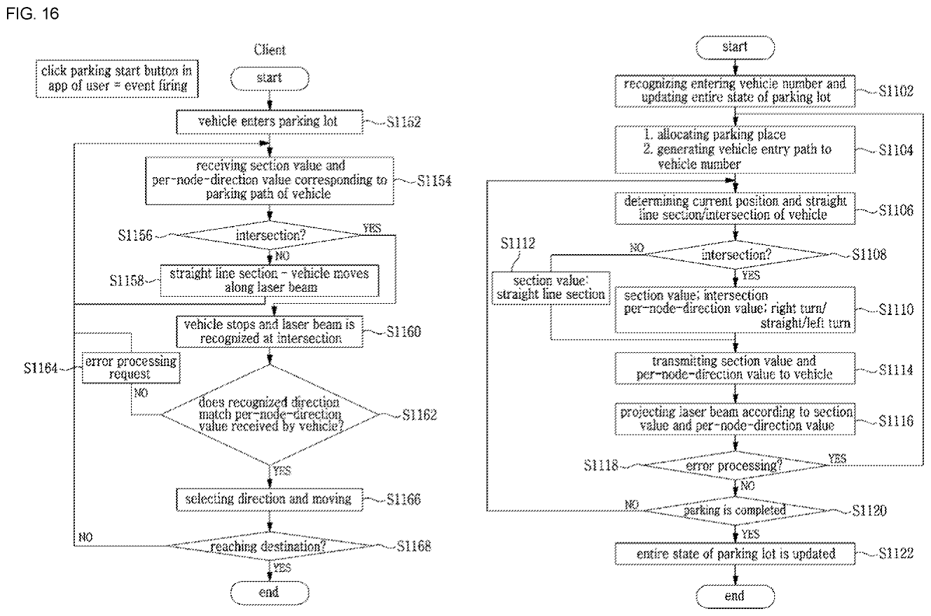

FIGS. 16A and 16B are flow diagrams showing an embodiment of a method of guiding a path of an unmanned autonomous vehicle at the time of vehicle entry according to the present invention.

In performing unmanned autonomous parking, the vehicle communicates with the unmanned autonomous vehicle supporting system in order to exchange necessary information. In FIGS. 16A and 16B, ‘client’ means a client vehicle controller provided in a vehicle, and ‘server’ means a server of the unmanned autonomous vehicle supporting system. Herein, the collision avoidance to cope with an obstacle or an unexpected situation, the standby mode according to crossing in the intersection or the straight line section, and the like are not within the range of the present invention, and thus will not described herein.

The vehicle 106 is driven along the laser beam projected on the floor of the parking lot. To this end, the vehicle 106 includes a camera for capturing the laser beam projected on the floor, and a line tracing controller for analyzing an image from the camera to extract the trajectory of the laser beam and controlling the vehicle to follow the extracted trajectory. Since these devices are configured to be the same as those required for no Lal line tracing, a detailed description thereof will be omitted.

The client vehicle controller mounted on the vehicle 106 entering the parking lot recognizes the parking lot entrance and transmits a vehicle entry signal to the unmanned autonomous vehicle supporting system (not shown). The client vehicle controller recognizes the parking lot entrance by capturing and analyzing an entry display image provided at the parking lot entrance using the built-in camera, or recognizes the parking lot entrance by receiving a beacon signal transmitted from a beacon signal generator provided at the parking lot entrance.

The unmanned autonomous vehicle supporting system recognizes the vehicle number of the entering vehicle 106 by the entrance-side camera 202 in response to the vehicle entry signal, allocates a suitable parking plane PA to the corresponding vehicle 106, and then creates a vehicle entry path (S1102). The vehicle entry path may be a shortest distance algorithm or an algorithm that fills each parking section in sequence.

The unmanned autonomous vehicle supporting system determines the first laser beam projectors 210b, and the intersection camera and second laser beam projectors 220, and direction values at each node included in the determined vehicle entry path.

The current position and section (straight line section/intersection) of the vehicle are determined (S1106).

By referring the section value and the vehicle entry path, the section value and the per-node-direction value are determined (S1108, S1110, S1112).

Whether there is or not the straight line section/intersection is primarily determined by the intersection camera 220a provided at the node. When the vehicle 106 of the corresponding number enters the capturing range of the intersection camera 220a provided at the node, it is determined that the vehicle 106 of the corresponding number is located at the intersection.

When the vehicle 106 is not within the capturing range of the intersection camera 220a provided at the node, it is determined to be located in the straight line section. In the straight line section, the position of the vehicle 106 is determined by the proximity sensor 210a located between a node that the vehicle has passed previously and a node that the vehicle is to move next, on the vehicle entry path.

The unmanned autonomous vehicle supporting system transmits the section value and the per-node-direction value (right turn/straight/left turn) according to the current position of the vehicle 106 to the client vehicle controller (S1114) and controls the laser beam projector according to the section value and the per-node-direction value of the corresponding vehicle 106 (S1116).

If there is an error processing request (S1118), the process returns to the step S1104 to reset the parking plane and the vehicle entry path and perform the above process again.

It is determined whether or not parking is completed (S1120). When the parking is completed, the entire state of the parking lot is updated (S1122).

On the other hand, the operation of the corresponding client vehicle controller is performed as follows.

The client vehicle controller mounted on the entering vehicle 106 recognizes the parking lot entrance by receiving the beacon signal transmitted from the beacon signal generator provided at the parking lot entrance, and transmits the vehicle entry signal to the unmanned autonomous vehicle supporting system (S1152).

The client vehicle controller receives the section value and the per-node-direction value transmitted from the unmanned autonomous vehicle supporting system (S1154).

It is determined whether or not the vehicle is at the intersection, and when it is determined not to be in the intersection, that is, to be in the straight line section, the client vehicle controller performs control so that the vehicle 106 goes straight along a laser beam, that is, the laser beam projected by the first laser beam projector 210b or the second laser beam projector 220b (S1156, S1158).

When it is determined to be in the intersection, the client vehicle controller causes the vehicle 106 to be stopped once and then the laser beam projected by the second laser beam projector 220b to be recognized (S1160).

Herein, the unmanned autonomous vehicle supporting system recognizes the vehicle 106 being within the intersection range by using the intersection camera 220a located at a node (center of intersection) and operates the second laser beam projector 220b according to a direction value allocated to a specific node of the vehicle 106.

The client vehicle controller mounted on the vehicle 106 determines whether the direction value obtained by capturing and analyzing the laser beam projected onto the floor 46 of the parking lot matches the per-node-direction value of the vehicle 106 and performs control so that the vehicle is driven along the recognized direction when it is determined to be matched to each other.

When the direction value obtained by analyzing the recognized laser beam does not match the per-node-direction value of the vehicle 106, the client vehicle controller makes a request for error processing (S1164) and the process returns to S1154, whereby the section value and the per-node-direction value is received again, and the steps S1156 and S1160 are processed again.

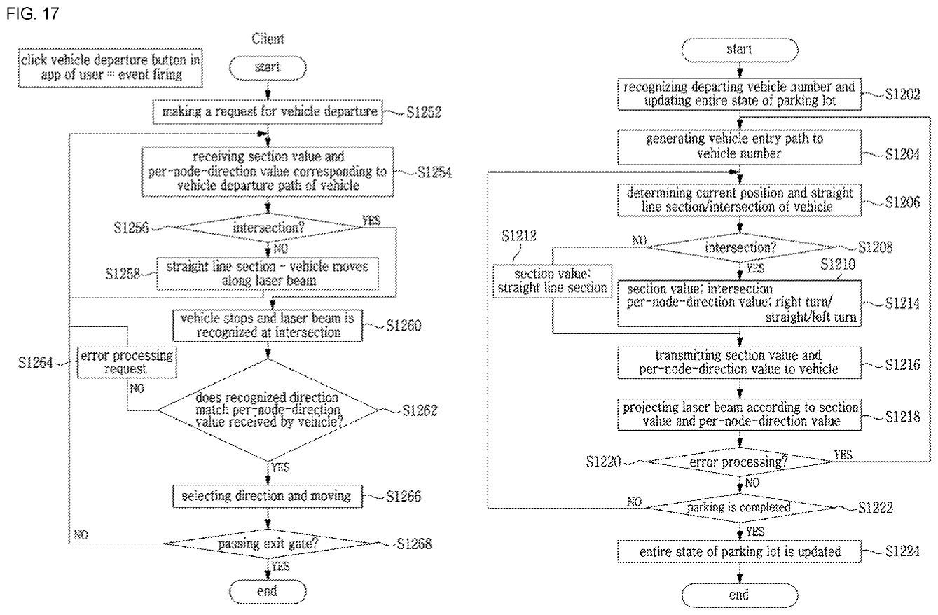

FIGS. 17A and 17B are flow diagrams showing another embodiment of a method of guiding a path of an unmanned autonomous vehicle at the time of vehicle departure according to the present invention;

In describing the vehicle departure process, parking fee settlement is not within the scope of the present invention and thus will be excluded from the discussion.

The client vehicle controller mounted on the vehicle departing the parking lot transmits a vehicle departure signal to the unmanned autonomous vehicle supporting system.

The unmanned autonomous vehicle supporting system generates the vehicle departure path in response to the vehicle departure signal (S1202, S1204).

The unmanned autonomous vehicle supporting system determines the proximity sensor and first laser beam projector 210, the intersection camera and second laser beam projector 220, and the per-node-direction values included in the determined vehicle departure path.

The current position and the section (straight line section/intersection) of the vehicle 106 are determined, and the section value and the per-node-direction value are determined by referring the vehicle departure path (S1206, S1208, S1210, S1212).

The unmanned autonomous vehicle supporting system transmits the section value and the per-node-direction value (right turn/straight/left turn) to the client vehicle controller (S1216) and controls the laser beam projector according to the section value and the node-direction value of the corresponding vehicle 106 (S1218).

When there is an error processing request (S1220), the process returns to step S1204 to reset the vehicle departure path and perform the steps S1206 to S1218 again.

When the vehicle 106 passes the exit gate (S1222), the entire state of the parking lot is updated (S1224). Whether or not the vehicle 106 departs may be determined by the exit-side camera 204 or the parking entry/exit detector (not shown).

On the other hand, the operation of the corresponding client vehicle controller is performed as follows.

The client vehicle controller mounted on the vehicle departing the parking lot transmits the vehicle departure signal to the unmanned autonomous vehicle supporting system (S1252).

The client vehicle controller receives the section value and the per-node-direction value transmitted from the unmanned autonomous vehicle supporting system (S1254).

It is determined whether or not the vehicle is at the intersection, and when it is determined not to be at the intersection, that is, to be in the straight line section, the client vehicle controller performs control so that the vehicle goes straight along a laser beam, that is, a laser beam projected by the first laser beam projector 210b or the second laser beam projector 220b (S1256, S1258).

When it is determined to be at ‘the intersection’, the client vehicle controller performs control so that the vehicle 106 is stopped once and then the laser beam projected by the second laser beam projector 220b is recognized (S1260).

Herein, the unmanned autonomous vehicle supporting system recognizes the vehicle 106 being within the intersection range by using the intersection camera 220a located at a node (the center point of intersection) and operates the second laser beam projector 220b according to a direction value allocated to a specific node of the vehicle 106.

The client vehicle controller mounted on the vehicle 106 determines whether the direction value obtained by analyzing the laser beam recognized by its own camera matches the per-node-direction value received by the vehicle 106 and performs control so that the vehicle is driven along the recognized direction when it is determined it is matched to each other (S1262, S1266).

When the direction value obtained by analyzing the laser beam recognized by its own camera does not match the per-node-direction value received by the vehicle 106 in the step S1262, the client vehicle controller makes a request for error processing to the unmanned autonomous vehicle supporting system (S1164) and the process returns to the step S1154, to receive the section value and the per-node-direction value again and perform the steps S1254 to S1260 again.

When the vehicle passes the exit gate (S1268), the vehicle departure process is terminated.

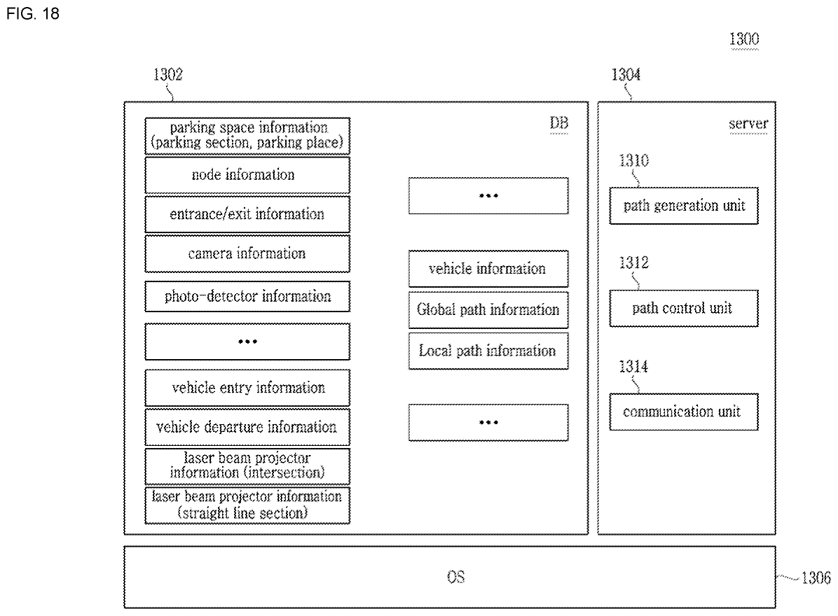

FIG. 18 is a block diagram showing a configuration of an unmanned autonomous vehicle supporting system to which a method of guiding a path of an unmanned autonomous vehicle according to the present invention is applied.

Referring to FIG. 18, the unmanned autonomous vehicle supporting system 1300 according to the present invention is implemented by a computer and includes a database 1302, a server 1304, and an operating system (OS) 1306. The unmanned autonomous vehicle supporting system 1300 is connected wired or wirelessly to a plurality of proximity sensors and first laser beam projectors 210, a plurality of intersection cameras and second laser beam projectors 220, a straight line section camera 212, an entrance-side camera 202, and an exit-side camera 204, and the like, and is wirelessly connected to the client vehicle controller of the vehicle.

The database 1302 stores parking space information (parking section, parking plane), node information, entrance/exit information, intersection camera information, straight line section camera information, proximity sensor information, vehicle entry path information, vehicle departure path information, laser beam projector information (intersection), laser beam projector information (straight line section), and the like.

In addition, the database 1302 stores vehicle information, global path information, local path information, and the like. The global path is information that notifies the approximate position of the vehicle, such as between the first node and the second node, and the local path is information that notifies the precise position of the vehicle, such as a coordinate (X, Y) between the first node and the second node.

The server 1302 includes a path generation unit 1310, a path control unit 1312, and a communication unit 1314. The path generation unit 1310 and the path control unit 1312 may be constituted by programs or modules. The path generation unit 1310 performs parking plane allocation and optimal driving guidance path generation. The path control unit 1312 controls the laser beam projectors 210b and 220b according to the generated driving guidance path. The communication unit 1314 transmits the section value indicating the straight line section/intersection and the per-node-direction value to the vehicle 106 by referring the current position and the driving guidance path of the vehicle 106.

The path control unit 1312 may make colors of the laser beams different to indicate the vehicle entry path and the vehicle departure path. For example, the path control unit 1312 may perform control so that a blue laser beam is projected for the vehicle entry path and a red laser beam is projected for the vehicle departure path.

In addition, the path control unit 1312 may make the curvature of the projected laser beam different according to the vehicle width (width), the length of the vehicle, the road width, and the like at the intersection.

In addition, the path control unit 1312 may make the laser beam colors different when two or more vehicles intersect with each other at the intersection.

The path control unit 1312 of the server 1304 includes a straight line section path control unit (Module 1) 1320 that is responsible for path control in the straight line section and an intersection path control unit (Module 2) 1340 that is responsible for path control at the intersection.

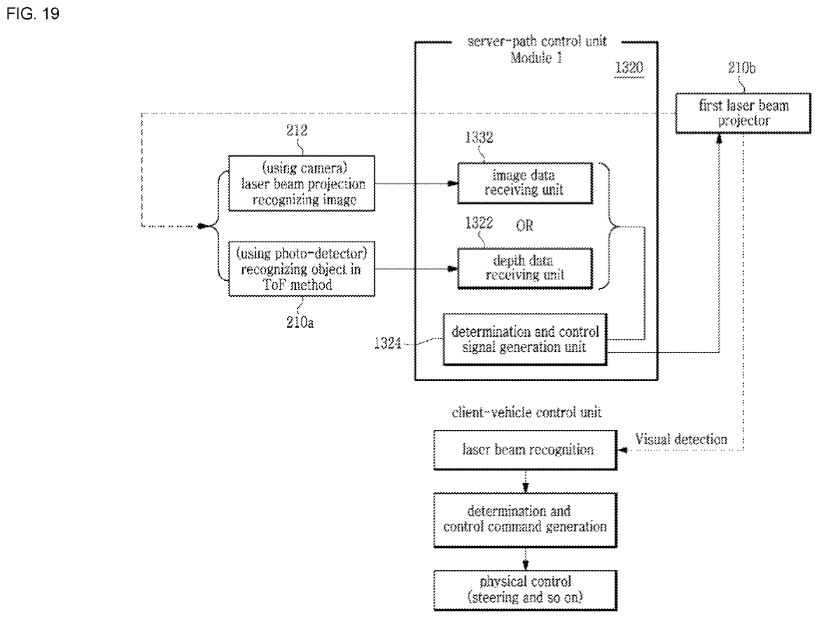

FIG. 19 shows a configuration of a straight line section path control unit.

Referring to FIG. 19, the straight line section path control unit 1320 recognizes the current position of the vehicle 106 using the straight line section camera 212 or the proximity sensor 210a, and generates a signal to control the first laser beam projector 210b according to the determined position. The control signal is applied to the first laser beam projector 210b, and the first laser beam projector 210b generates a laser beam according to the control signal. The generated laser beam is projected onto the floor 46 of the parking lot.

The straight line section path control unit 1320 includes a depth data receiving unit for receiving a detection signal of the proximity sensor 210a that detects the distance to the vehicle 106 and whether the vehicle 106 enters/exits the projecting range in the straight line section, and a straight line section determination and control signal generation unit 1324 for determining the current position of the vehicle 106 on the driving guidance path by referring the detection signal received by the depth data receiving unit 1322 and the position of the first laser beam projector 210b and generating a control signal that controls operations of the first laser beam projector 210b according to the determined current position.

The straight line section path control unit 1320 may further include a straight line section image data receiving unit 1322 that receives the image data transmitted from the straight line section camera 212 provided in the straight line section.

It is possible to achieve vehicle information (vehicle number, an outline of the vehicle, a height of the vehicle, a width of the vehicle, etc.) and the distance to the vehicle, from the image data received from the straight line section camera 212.

On the other hand, when the proximity sensor 210a is used, the distance to the vehicle may be obtained by a time of flight (TOF) method.

Since the positions of the proximity sensor 210a and the straight line section camera 1330 are mapped to the parking space information, the two-dimensional coordinates of the vehicle 106 in the parking space are obtained by referring the distance to the vehicle 106. By comparing the two-dimensional coordinates of the vehicle 106 with the driving guidance path, it is possible to determine the position of the vehicle 106 and whether there is the straight line section/intersection on the driving guidance path.

Meanwhile, the client vehicle controller recognizes the laser beam projected on the floor 46 of the parking lot, determines the driving direction, and controls the steering according to the determined driving direction.

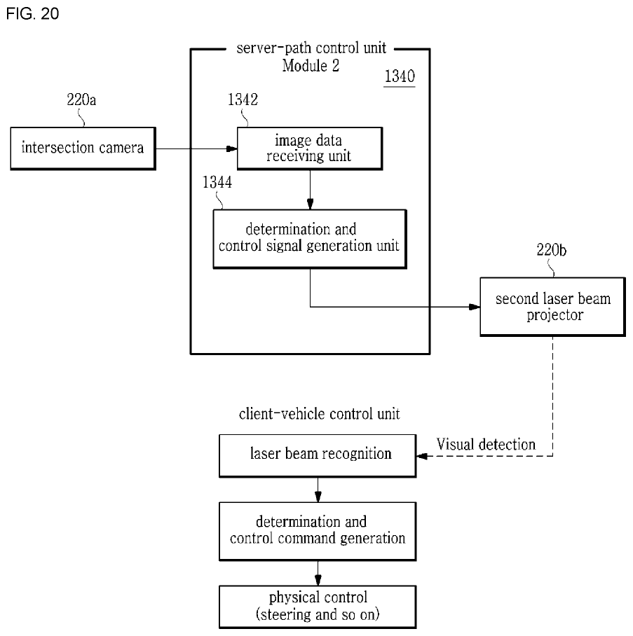

FIG. 20 shows a configuration of an intersection path control unit.

Referring to FIG. 20, the intersection path control unit 1340 recognizes the current position of the vehicle 106 using the intersection camera 220a provided at the node and generates a control signal that controls the second laser beam projector 220b according to the determined position. The control signal is applied to the second laser beam projector 220b, and the second laser beam projector 220b generates a laser beam according to the control signal. The generated laser beam is projected onto the floor 46 of the parking lot.

The intersection path control unit 1340 includes an intersection image data receiving unit 1342 for receiving image data provided from the intersection camera 220a that captures an image of the vehicle entering the intersection, and an intersection determination and control signal generating unit 1344 for analyzing the image date received from the image data receiving unit 1342 to determine whether the vehicle 106 has entered the intersection and generating a control signal that controls operations of the second laser beam projector 220b according to the determination result.

When the vehicle 106 enters within the capturing range of the intersection camera 220a provided at the node, it is determined that the vehicle has entered the intersection. The direction value at the corresponding node may be determined by comparing the vehicle number and the driving guidance path set for the vehicle.

The intersection path control unit 1340 may vary the curvature of the laser beam projected from the intersection depending on the width of the vehicle, the length of the vehicle, the road width, and the like.

In addition, the intersection path control unit 1340 may make the color of the laser beam different when two or more vehicles intersect with each other at the intersection.

On the other hand, the client vehicle control unit recognizes the laser beam projected on the floor of the parking lot, determines the driving direction, and controls the steering according to the determined driving direction.

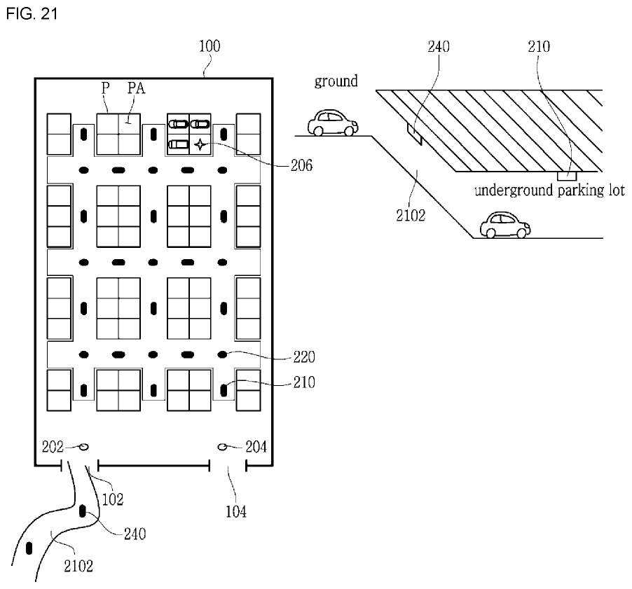

FIG. 21 shows another example of a parking lot. Referring to FIG. 21, it is shown that a via-passage 2102 is disposed outside the parking lot 100. Herein, the via-passage 2102 refers to a space between a ground and an underground parking lot through which the vehicle passes to enter the underground from the ground, a space through which the vehicle passes to move between an upper floor and a lower floor, and so on. Such a via-passage 2102 mostly has a steep turning section of 45 degrees or more, and it is restricted that the vehicle has to pass through the via-passage and must not park in the via-passage.

The third laser beam projector 240 may be provided in the via-passage 2102 to guide the vehicle using the laser beam.

In addition, the third laser beam projector 240 may be controlled to be operated from the moment the vehicle enters the via-passage 2102 until the vehicle exits the via-passage. To this end, entry/exit detectors (not shown) may be provided at both ends of the via-passage 2102 to detect the entry/exit of the vehicle.

In the embodiments of the present invention, various components within “server” and “application” are used herein to include any combination of hardware, firmware, and software employed in processing data or digital signals. The hardware components may include programmable logic devices such as, for example, application specific integrated circuits (ASICs), general purpose or special purpose central processing units (CPUs), digital signal processors (DSPs), graphics processing units (GPUs), and field programmable gate arrays (FPGAs). Within the control unit, as used herein, each function may be implemented by more general purpose hardware, configured to perform the function, such as a hard-wired hardware, or a CPU configured to execute instructions stored in non-temporary storage medium. The control unit may be fabricated on a single printed circuit board (PCB) or distributed over several interconnected PCBs. The processing portion may include other processing portions; for example, the processing unit may include two processing units interconnected on the PCB.

The method according to the present invention may be programmed in the memory. “Memory” refers to any non-temporary medium that stores data and/or instructions that cause the machine to operate in a particular manner. Such storage media may include non-volatile media and/or volatile media. For example, non-volatile media include optical or magnetic disks. For example, volatile media includes dynamic memory. The storage media of general form include, for example, a floppy disk, a flexible disk, a hard disk, a solid state drive, a magnetic tape, or any other magnetic data storage medium, CD-ROM, any other optical data storage medium, any physical medium having hole pattern, RAM, PROM, and EPROM, FLASH-EPROM, NVRAM, and any other memory chip or cartridge.

It will be understood by those skilled in the art that various changes in form and details may be made therein without departing from the spirit and scope of the invention as defined in the appended claims.

1. A method of guiding a path of an unmanned autonomous vehicle using a system for supporting the unmanned autonomous vehicle, the method comprising:
preparing parking space information represented by a two-dimensional coordinate system and including a parking section and a parking plane in a parking lot (parking space information preparation step);
mapping positions of a plurality of intersection cameras and second laser beam projectors provided at each of a plurality of intersections and positions of a plurality of proximity sensors and second laser beam projectors provided in straight line sections between the intersections adjacent to each other, to the parking space information (a mapping step);
allocating a driving guidance path including the straight line sections and the intersections to a vehicle to be guided to be driven and determining the proximity sensor and first laser beam projectors, the intersection cameras and second laser beam projectors, and per-node(a center point of the intersection)-direction values included in the allocated driving guidance path (path acquisition step); and
displaying a lane on which the vehicle moves by the first laser beam projector in the straight line section and displaying a lane on which the vehicle moves by the second beam projector according to the per-node-direction value at the intersection, when guiding the vehicle according to a current position of the vehicle and the determined driving guidance path (path guiding step).

2. The method of claim 1, further comprising:
transmitting a section value indicating the straight line section or the intersection and the per-node-direction value to the vehicle.

3. The method of claim 2, further comprising:
determining, by the vehicle, a direction value indicated by a laser beam projected on a floor of the parking lot and comparing the direction value with a direction value received by the vehicle to move in a direction indicated by the laser beam when both values match each other, at the intersection.

4. The method of claim 3, further comprising:
transmitting, by the vehicle, an error information to the unmanned autonomous driving support system when both values does not match each other; and
returning to the driving guidance path acquisition step to reset the driving guidance path and perform the path guiding step again when the unmanned autonomous driving support system receives the error information.

5. The method of claim 1, wherein the path guiding step includes:
projecting a laser beam indicating a moving direction of the vehicle onto a front parking plane of the vehicle; and
reducing a length of the projected laser beam in accordance with a moving speed of the vehicle,
wherein the length of the projected laser beam is reduced in accordance with the moving speed of the vehicle to cause the laser beam not to be projected onto a driver's seat of the vehicle.

6. The method of claim 5, wherein a plurality of laser beam projectors for generating laser beams are provided along a direction in which the vehicle moves and a proximity sensor is provided for each of the laser beam projectors to detect whether the vehicle enters and exits a region on which the laser beam is projected, and
the reducing of the length of the projected laser beam includes determining the moving speed of the vehicle by analyzing a time between detection signals generated by the proximity sensors.

7. The method of claim 5, wherein the reducing of the length of the projected laser beam includes determining the moving speed of the vehicle by analyzing an image data acquired by capturing the vehicle using a camera.

8. The method of claim 1, wherein when the vehicle reaches a parking position (position adjacent to the parking plane), the laser beam is no longer projected except for a last section, thereby indicating an end of the guidance path.

9. The method of claim 8, wherein when the vehicle reaches the parking position (position adjacent to the parking plane), the laser beam is repeatedly turned on or off at the last section, thereby indicating the end of the guidance path.

10. The method of claim 1, wherein when the vehicle reaches a vehicle departure position (position adjacent to an exit), the laser beam is no longer projected except for a last section, thereby indicating an end of the guidance path.

11. The method of claim 10, wherein when the vehicle reaches the vehicle departure position (position adjacent to the exit), the laser beam is repeatedly turned on or off at the last section, thereby indicating the end of the guidance path.

12. An unmanned autonomous driving support system, comprising:
an intersection camera and second laser beam projector provided at a node (a center point of an intersection) of a parking space;
a proximity sensor and first laser beam projector provided at a straight line section between the nodes;
database having a parking section and a parking plane displayed by a two-dimensional coordinate system and storing parking space information to which positions of the intersection camera and second laser beam projector and the proximity sensor and first laser beam projector are mapped;
a path setting unit determining a start position and an end position of a vehicle to be guided to be driven, setting a driving guidance path from the start position to the end position by referring the parking space information stored in the database, and determining nodes and per-node-direction values included in the driving guidance path;
a path control unit determining a current position of the vehicle on the basis of detection results of the proximity sensor and the intersection camera, and controlling the first laser beam projector and the second laser beam projector according to the determined current position to allow the vehicle to be driven according the driving guidance path; and
a communication unit transmitting section values indicating straight line section/intersection and the per-node-direction values to the vehicle by referring the current location and the driving guidance path of the vehicle.

13. The system of claim 12, wherein colors of laser beams for indicating a vehicle entry path and a vehicle departure path are made different from each other.

14. The system of claim 12, wherein the path control unit includes:
a straight line section path control unit performing a path control in the straight line section; and
an intersection path control unit performing a path control at the intersection.

15. The system of claim 14, wherein the straight line section path control unit includes:
a proximity sensor output receiving unit receiving a detection signal of the proximity sensor provided in each of the first laser beam projectors in the straight line section; and
a straight line section determination and control signal generating unit determining the current position of the vehicle on the driving guidance path by referring the detection signal received by the proximity sensor output receiving unit and a position of the first laser beam projector and generating a control signal that controls an operation of the first laser beam projector according to the determined current position.

16. The system of claim 15, wherein the straight line section path control unit determines a moving speed of the vehicle on the basis of detection signals of the proximity sensors adjacent to each other and controls a projection range of the first laser beam projector according to the moving speed of the vehicle.

17. The system of claim 15, further comprising:
a plurality of straight line section cameras provided in the straight line sections between the nodes to capture an image data of the vehicle; and
a straight line section image data receiving unit receiving the image data captured by the straight line section cameras,
wherein the straight line section path control unit controls the first laser beam projector on the basis of the position of the vehicle determined by the proximity sensor and the position of the vehicle determined by the straight line section camera.

18. The system of claim 17, wherein the straight line section path control unit determines a moving speed of the vehicle on the basis of the detection signal of the adjacent proximity sensors and the image signal of the straight line section camera and adjust a projection range of the first laser beam projector according to the moving speed of the vehicle.

19. The system of claim 14, wherein the intersection path control unit includes:
an intersection image data receiving unit receiving an image data provided by the intersection camera capturing the vehicle entering the intersection; and
an intersection determination and control signal generating unit analyzing the image data received by the image data receiving unit to determine whether the vehicle enters the intersection and generating a control signal controlling an operation of the second laser beam projector according to the determination result.

20. The system of claim 19, wherein a curvature of the laser beam projected at the intersection is made different according to a width of the vehicle, a length of the vehicle, and a road width.

21. The system of claim 19, wherein colors of the laser beams are made different when two or more vehicles intersect with each other at the intersection.

22. The system of claim 19, wherein the intersection path control unit determines a moving speed of the vehicle on the basis of the image signal of the intersection camera and adjusts a projection range of the second laser beam projector according to the moving speed of the vehicle not to project the laser beam onto a driver's seat of the vehicle.

23. The system of claim 14, wherein the second laser beam projector includes:
first to third sub laser beam projectors generating laser beams to be projected on a floor of the parking lot respectively; and
a controller controlling the first to third sub laser beam projectors according to control of the intersection path control unit,
wherein the first and third sub laser beam projectors project laser beams having predetermined curvatures, respectively, and the second sub laser beam projector projects a linear laser beam.
